(19) United States
(12) Patent Application Publication
(10) Pub. No.: US 2020/0004608 A1
(43) Pub. Date: Jan. 2, 2020

(54) INFORMATION PROCESSING DEVICE AND INFORMATION PROCESSING METHOD

(71) Applicant: NIDEC SANKYO CORPORATION, Nagano (JP)

(72) Inventor: Tsutomu BABA, Nagano (JP)

(21) Appl. No.: 16/454,607

(22) Filed: Jun. 27, 2019

(30) Foreign Application Priority Data
Jun. 29, 2018 (JP) 2018-124590

(51) Int. Cl. G06F 9/54; G06K 7/00; G06F 21/54

(52) U.S. Cl. CPC G06F 9/542; G06F 21/54; G06K 7/0008

(57) ABSTRACT

An information processing device may include a master device, a slave device, a state notification line for notifying a state of the slave device to the master device, and a communication line connected between the master device and the slave device. The master device may include a state notification detection part for detecting the state of the slave device, a state request part for transmitting a state request command to the slave device, and a state processing execution part for performing processing corresponding to the state. The slave device may include a state notification part for notifying a change of the state to the master device through the state notification line, and a state reply part which replies the data indicating the state in a case that the state reply part receives the state request command from the master device through the communication line.

### CROSS REFERENCE TO RELATED APPLICATION

The present invention claims priority under 35 U.S.C. § 119 to Japanese Application No. 2018-124590 filed Jun. 29, 2018, the entire content of which is incorporated herein by reference.

### TECHNICAL FIELD

At least an embodiment of the present invention may relate to an information processing device and an information processing method, and especially, to an information processing device and an information processing method in which a master device and a slave device are capable of communicating with each other.

### BACKGROUND

Conventionally, there is an information processing device such as a card reader in which a master device and a slave device are capable of communicating with each other. For example, in Patent Literature 1 (Japanese Patent Laid-Open No. 2014-67230), an information processing device is described which includes a master device and a slave device connected with each other through two kinds of signal lines, i.e., a clock signal line and a data signal line, and data are transmitted by a predetermined communication system.

In such an information processing device, when state recognition for a slave device is to be performed, a master device transmits a state notification request command through a communication line. When the state notification request command is received, the slave device returns its present state as a response to the master device.

However, in the conventional information processing device as described in Patent Literature 1, the master device is required to periodically communicate with the slave device and thus, a processing load is large.

### SUMMARY

In view of the problems described above, at least an embodiment of the present invention may advantageously provide an information processing device in which a processing load of state recognition is reduced.

According to at least an embodiment of the present invention, there may be provided an information processing device including a master device and a slave device capable of communicating with each other, a state notification line connected between the master device and the slave device for performing a state notification of the slave device, and a communication line connected between the master device and the slave device for transmitting and receiving an instruction and data. The master device includes a state notification detection part which detects the state notification from the slave device through the state notification line, a state request part which transmits a state request command through the communication line, the state request command being the instruction for making transmit data indicating a state in a case that the state notification is detected by the state notification detection part, and a state processing execution part which performs processing corresponding to the state in a case that the data indicating the state are acquired by the state request part. The slave device includes a state notification part which performs the state notification to the master device through the state notification line corresponding to a change of the state, and a state reply part which replies the data indicating the state in a case that the state reply part receives the state request command from the master device through the communication line corresponding to the state notification of the state notification part. According to this structure, a processing load of the state recognition can be reduced.

In the information processing device in at least an embodiment of the present invention, the state notification is a notification of the state corresponding to warning of security caused by an illegal operation, and the state processing execution part executes the processing relating to a security error when the illegal operation has been performed. According to this structure, regarding warning of security, a change of the state is surely recognized and processing relating to a security error can be executed.

In the information processing device in at least an embodiment of the present invention, the master device is a main processing device which monitors a state of a card medium detection sensor and controls various drive mechanisms, and the slave device is a sub-processing device which executes encryption of the information, processes the encrypted information, and controls writing and reading of information to and from a card medium. According to this structure, a processing load of state recognition relating to encryption processing can be reduced.

In the information processing device in at least an embodiment of the present invention, the information processing device is a card reader. According to this structure, a card reader in which a processing load of state recognition is reduced can be provided.

An information processing method in at least an embodiment of the present invention is an information processing method executed by an information processing device which includes a master device and a slave device capable of communicating with each other, a state notification line connected between the master device and the slave device for performing a state notification of the slave device, and a communication line connected between the master device and the slave device for transmitting and receiving an instruction and data. The information processing method includes performing the state notification by the slave device to the master device through the state notification line corresponding to a change of the state, detecting the state notification by the master device from the slave device through the state notification line, in a case that the state notification is detected by the master device, transmitting a state request command which is the instruction for making transmit data indicating the state by the master device through the communication line, replying the data indicating the state by the slave device in a case that the state request command is received from the master device through the communication line corresponding to the state notification, and performing processing corresponding to the state by the master device in a case that the data indicating the state are acquired. According to this structure, a processing load of state recognition can be reduced.

According to at least an embodiment of the present invention, a state notification line performing a state notification of the slave device and a communication line for transmitting and receiving an instruction and data are connected between the master device and the slave device. The state notification is performed from the slave device to the master device through the state notification line corresponding to a change of the state and, when the state notification is detected in the master device, a state request command is transmitted through the communication line, data indicating the state are replied by the slave device and, when the master device acquires the data, the processing corresponding to the state is performed. According to this structure, an information processing device can be provided in which monitoring of the state notification line is always performed with less influence on other processing and a processing load of state recognition of the slave device can be reduced.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a system configuration diagram of an information processing system “X” in accordance with an embodiment of the present invention.

FIG. 2 is a flow chart of state recognition corresponding processing in accordance with an embodiment of the present invention.

FIG. 3A through FIG. 3C are concept diagrams of the state recognition corresponding processing shown in FIG. 2.

FIG. 4A through FIG. 4C are concept diagrams of the state recognition corresponding processing shown in FIG. 2.

### DETAILED DESCRIPTION

### Embodiments

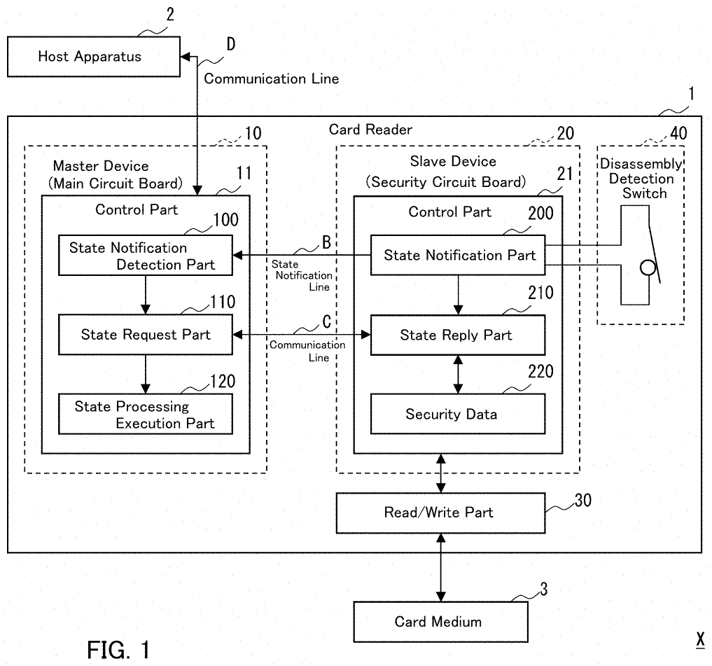

A configuration of an information processing system “X” in accordance with an embodiment of the present invention will be described below with reference to FIG. 1. In this embodiment, the information processing system “X” includes an ATM (Automated Teller Machine), a terminal of a kiosk, a ticket issue system of transportation, a point card issue system of a convenience store or the like, a member card issue system of a retail store, a card issue/payment system of an game machine, an entrance/exit management system or the like (hereinafter, simply referred to as “ATM or the like”), which are provided with a card issue function.

The information processing system “X” includes a card reader 1 and a host apparatus 2.

The card reader 1 is a device capable of reading from or writing in a card medium 3 which is a contact type or a non-contact type IC card and/or a magnetic card provided with a magnetic stripe. The card reader 1 is an example of the information processing device in this embodiment. A detailed structure of the card reader 1 will be described below.

The host apparatus 2 is a main apparatus which is structured to realize respective functions of an ATM or the like. Specifically, the host apparatus 2 includes, for example, a control calculation device such as a PC (Personal Computer), a tablet terminal or a cellular phone for controlling respective parts, and executes applications (Application Program, not shown) for realizing functions of the information processing system “X”. In addition, the host apparatus 2 is connected with peripheral devices such as a printer for printing or marking on a surface of a card medium 3, a display such as an LCD panel or an organic EL panel, a touch panel and buttons.

The card reader 1 and the host apparatus 2 are connected with each other through a communication line “D”. The communication line “D” is, for example, a general-purpose bus, serial, parallel, IP network or the like. Information including various instructions (command) and data can be transmitted and received through the communication line “D”.

More specifically, the card reader 1 is an information processing device including a master device 10, a slave device 20, a read/write part 30 and a disassembly detection switch 40. A state notification line “B” and a communication line “C” are connected between the master device 10 and the slave device 20.

The master device 10 is a main processing device structured to perform general processing as the card reader 1 and state monitoring of a detection sensor for a card medium 3 and to control various drive mechanisms. The master device 10 is, for example, configured as various circuits on a main circuit board for controlling the entire card reader 1. In this embodiment, the master device 10 controls the slave device 20 connected with the master device 10 through communication and recognizes a change of a state.

The slave device 20 is a sub-processing device in which a security function for executing encryption of information or processing encrypted information is realized, and writing and reading of information to and from a card medium 3 are controlled. The slave device 20 is, for example, configured as various circuits on a security circuit board which is connected with the master device 10. In this embodiment, the slave device 20 is configured in accordance with PCI (Payment Card Industry) standard to realize a security function of the card reader 1. Therefore, the slave device 20 is, for example, provided with a data encryption function, a decryption function and an illegal modification detection function of the card reader 1 for preventing a swindle of data such as an ID, a personal identification number and a password stored in a card medium 3, and the like.

The read/write part 30 is a configuration part including a magnetic head, an electromagnetic induction coil, terminals and the like for performing reading from and writing to a card medium 3, and circuits for the processing.

The disassembly detection switch 40 is a sensor, a switch or the like for detecting an illegal operation to the card reader 1 such as detachment or modification of the card reader 1 and to the information processing system “X” such as opening/closing of a housing of the information processing system “X”.

The state notification line “B” is a signal line which outputs a logic for performing state monitoring. The state notification line “B” is, for example, provided as one of pins of GPIO (General-purpose input/output). In this case, the state notification line “B” notifies a state from the slave device 20 to the master device 10 by inversion of the logic. Monitoring of a logic change of the state notification line “B” can be processed by reading and writing of a control register and thus, other processings are hardly affected. Further, the monitoring of the logic change can be performed by setting an interrupt to a control part 21 of the slave device 20.

The communication line “C” is, for example, a signal line such as a general-purpose bus, serial or parallel. The communication line “C” is capable of transmitting and receiving information including various instructions (command) and data between the master device 10 and the slave device 20.

More specifically, the master device 10 includes a control part 11. The slave device 20 includes the control part 21.

The control part 11 is a control calculation means such as a CPU (Central Processing Unit), MPU (Micro Processing Unit), GPU (Graphics Processing Unit), DSP (Digital Signal Processor) or ASIC (Application Specific Integrated Circuit) configured to perform a state monitoring and control of the master device 10.

In addition, the control part 11 includes non-transitory storage media such as a RAM (Random Access Memory), ROM (Read Only Memory) and flash memory. The storage medium of the control part 11 stores a control program (embedded software) of the control part 11 which is mounted on the master device 10. The control program incorporates processing such as monitoring of a sensor for detecting a card medium 3, control of a drive mechanism of the card reader 1 and control of the slave device 20.

The control part 21 is a control calculation means such as a CPU, MPU, GPU, DSP or ASIC configured to perform a state monitoring and control of the slave device 20. The control part 21 includes, for example, an accelerator which exclusively executes hash arithmetic operations for various encryption and decryption in a system such as AES (Advanced Encryption Standard).

Further, the control part 21 includes non-transitory storage media such as a RAM, ROM, and flash memory. The storage medium of the control part 21 stores a control program (embedded software) of the control part 21. In addition, the control part 21 is also capable of acquiring information of the master device 10, other configuration parts and sensors provided in the device. Further, processing such as reading and writing of a card medium 3 is also incorporated in the control program.

More specifically, the control part 11 of the master device 10 includes a state notification detection part 100, a state request part 110 and a state processing execution part 120 as the function configuration parts. The control part 21 of the slave device 20 includes a state notification part 200 and a state reply part 210 as the function configuration parts. In addition, the control part 21 of the slave device 20 stores security data 220 in the recording medium.

The state notification detection part 100 detects a state notification from the slave device 20 through the state notification line “B”. In this embodiment, the state notification is, for example, a notification of a state corresponding to a warning of security due to an illegal operation. Specifically, the state notification detection part 100 detects that a state notification has been performed when the logic of the state notification line “B” is inverted.

The state request part 110 transmits a state request command through the communication line “C” in a case that the state notification has been detected by the state notification detection part 100. A state request command in this embodiment is an instruction for making transmit data indicating the state. The data indicating the state are, for example, data indicating a security state of the card reader 1.

In a case that the data indicating the state are acquired by the state request part 110, the state processing execution part 120 performs processing corresponding to the state. In this embodiment, the state processing execution part 120 executes processing relating to a security error when an illegal operation has been performed.

The state notification part 200 performs a state notification to the master device 10 through a notification line corresponding to a change of a state. In this embodiment, the state notification part 200 inverts the logic of the state notification line “B” as a notification of the state, or as a warning of security when an illegal operation is detected.

The state reply part 210 replies data indicating the state when received a state request command from the master device 10 through the communication line “C” corresponding to the state notification by the state notification part 200.

The security data 220 are key data for encryption, and a hash value and a CRC value (Cyclic Redundancy Code) for security inspection.

In this embodiment, the control part 11 functions as the function configuration parts, i.e., as the state notification detection part 100, the state request part 110 and the state processing execution part 120 by executing control programs stored in the built-in recording medium. The control part 21 functions as the state notification part 200 and the state reply part 210 by executing control programs stored in the built-in recording medium. Further, the respective above-mentioned parts of the card reader 1 are hardware resources for executing an information processing method in accordance with at least an embodiment of the present invention. In this case, a part or an arbitrary combination of the above-mentioned function configuration parts may be configured by using hardware such as an IC, programmable logic or FPGA (Field-Programmable Gate Array).

[State Recognition Corresponding Processing by Information Processing System “X”]

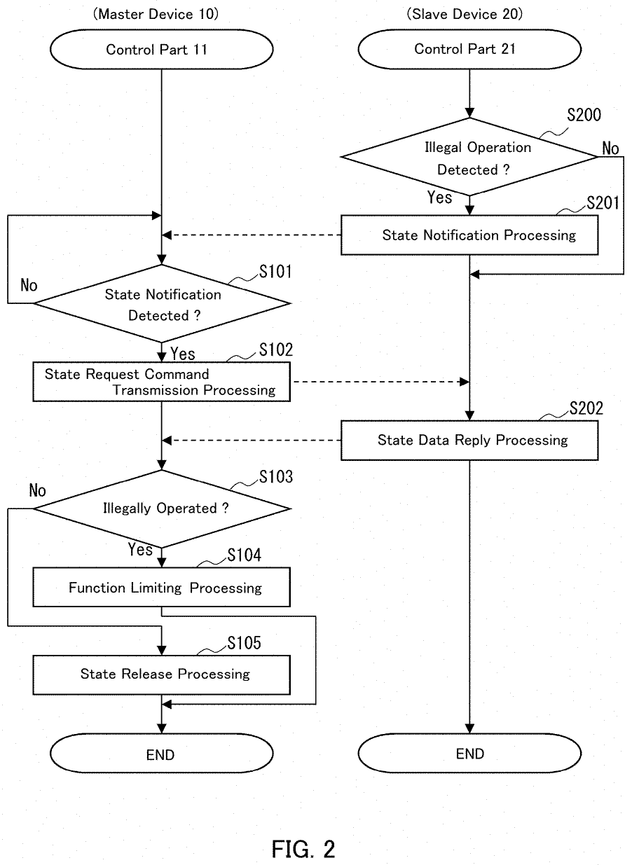

Next, state recognition corresponding processing which is executed by the card reader 1 of the information processing system “X” in accordance with at least an embodiment of the present invention will be described below with reference to FIG. 2. In the state recognition corresponding processing in this embodiment, the slave device 20 performs a state notification to the master device 10 through the state notification line “B” corresponding to a change of the state. When the master device 10 detects this state notification, the master device 10 transmits a state request command through the communication line “C”. When the slave device 20 receives this state request command, the slave device 20 replies data indicating the state. On the other hand, when the master device 10 acquires data indicating the state, the master device 10 performs processing corresponding to the state. The state recognition corresponding processing in this embodiment is executed so that the control part 11 of the master device 10 and the control part 21 of the slave device 20 mainly execute control programs stored in the built-in storage media and the hardware resources are used in cooperation with the respective parts. In the following descriptions, details of operation history storage processing are described for each step with reference to the flow chart in FIG. 2.

(Step S200)

First, the state notification part 200 of the slave device 20 determines whether an illegal operation has been detected or not. The state notification part 200 determines “Yes” when an illegal operation to the card reader 1 or the information processing system “X” has been detected by the disassembly detection switch 40 or the like. The state notification part 200 determines “No” in other cases. In the case of “Yes”, the state notification part 200 advances the processing to the step S201. In the case of “No”, the state notification part 200 advances the processing to the step S202.

(Step S201)

When an illegal operation is detected, the state notification part 200 performs the state notification processing. First, the state notification part 200 immediately erases the security data 220 to be unable to utilize a security function. In addition, the state notification part 200 inverts the logic of the state notification line “B” and thereby the state is notified to the master device 10 through the state notification line “B”. In this embodiment, a state that an illegal operation has been detected is notified through the state notification line “B”.

(Step S101)

In this step, the state notification detection part 100 of the master device 10 determines whether a state notification has been detected or not. Specifically, the state notification detection part 100 periodically monitors the state notification line “B” connected with the slave device 20. Therefore, when the state notification detection part 100 detects inversion of the state notification line “B”, the state notification detection part 100 recognizes that “there is a possibility that an illegal operation has been performed”. When the state notification detection part 100 detects an inversion of the state notification line “B”, the state notification detection part 100 determines “Yes”. The state notification detection part 100 determines “No” in other cases. In the case of “Yes”, the state notification detection part 100 advances the processing to the step S102. In the case of “No”, the state notification detection part 100 waits until a state notification is sent from the slave device 20. During this time, the control part 11 is capable of performing other processing.

(Step S102)

When the state notification is detected, the state request part 110 performs state request command transmission processing. The state request part 110 transmits a state request command through the communication line “C”.

(Step S202)

In this step, the state reply part 210 performs state data reply processing. When the state reply part 210 receives a state request command transmitted from the master device 10 through the communication line “C”, the state reply part 210 replies response data. In this embodiment, the response data are data indicating the security state of the card reader 1. The security state is, for example, an “illegally operated” state in which an illegal operation has been detected in the step S201 or a “no illegally operated” state in which an illegal operation is not detected. After that, the state reply part 210 finishes the state recognition corresponding processing and detection of an illegal operation is continued by the disassembly detection switch 40.

(Step S103)

In this step, the state processing execution part 120 of the master device 10 determines whether an illegal operation has been performed or not. In this step, the state processing execution part 120 receives the response data from the slave device 20 through the communication line “C”. When received, the state processing execution part 120 determines presence or absence of an illegal operation to the card reader 1 or the information processing system “X” on the basis of the response data. Specifically, the state processing execution part 120 determines “Yes” in a case that the response data indicate an “illegally operated” state, in other words, when an illegal operation has been performed. The state processing execution part 120 determines “No” in a case of a “no illegally operated” state, in other words, when an illegal operation is not detected. In the case of “Yes”, the state processing execution part 120 advances the processing to the step S104. In the case of “No”, the state processing execution part 120 advances the processing to the step S105.

(Step S104)

In the case that the response data indicate the “illegally operated” state, the state processing execution part 120 performs function limiting processing. The state processing execution part 120 recognizes that an illegal operation has been actually performed and, after that, the state processing execution part 120 sets a security error state and limits a function which can be performed by the card reader 1. The limited function may include, for example, that the state processing execution part 120 notifies a security error to the host apparatus 2 through the communication line “D” and waits so that only a restart or a reset is accepted. Further, it may be structured that a drive mechanism is driven so as to hold a card medium 3 in an inside of a housing without ejecting from the read/write part 30.

(Step S105)

In the case that the response data indicate a “no illegally operated” state, the state processing execution part 120 performs state release processing. The state processing execution part 120 determines that the former logic inversion in the state notification line “B” is a malfunction due to noise or the like and recognizes that an illegal operation is not detected and thus, the function limiting processing is not executed and the normal operation is continued. In this manner, the state recognition corresponding processing in accordance with an embodiment of the present invention is ended.

[Specific Example of State Recognition Corresponding Processing]

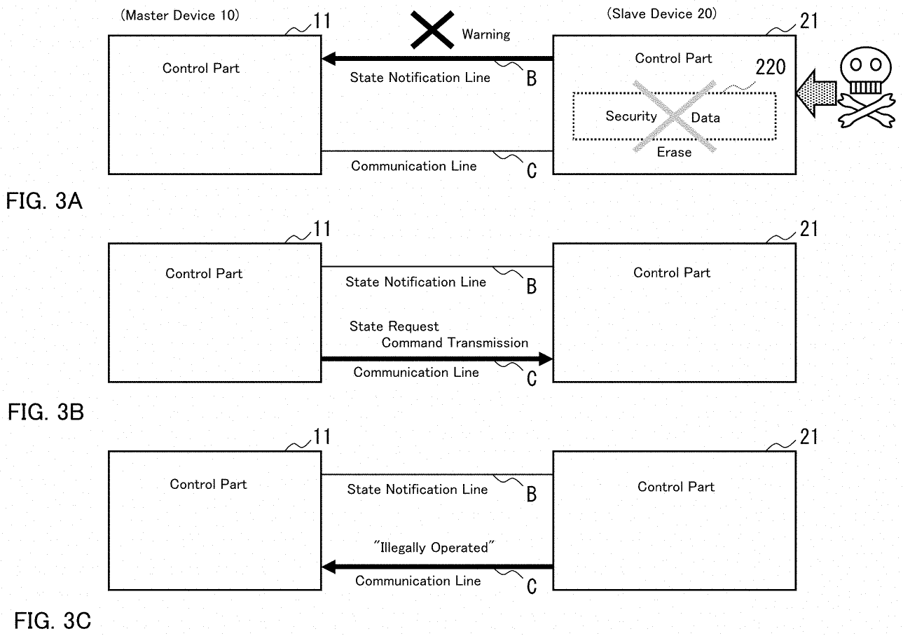

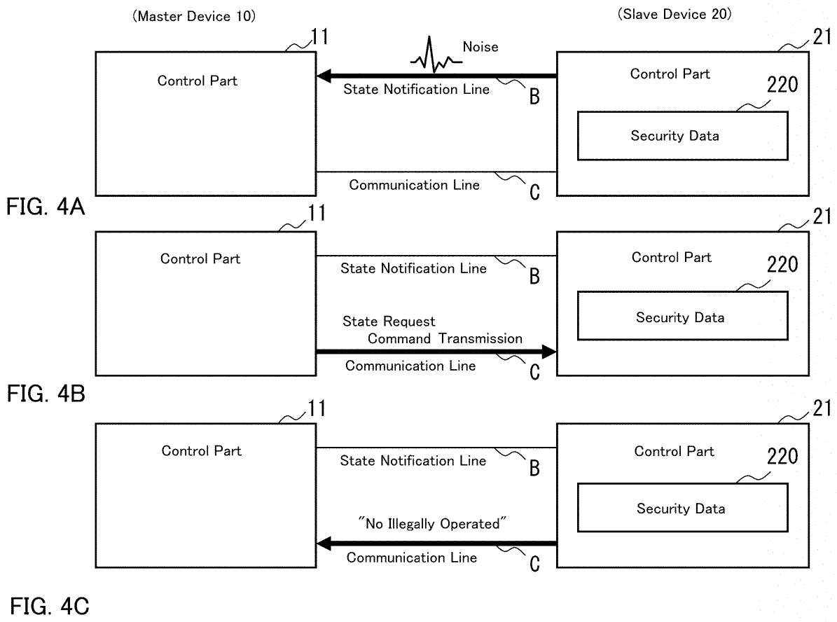

A specific example of the state recognition corresponding processing will be described below with reference to FIG. 3A through FIG. 3C and FIG. 4A through FIG. 4C. FIG. 3A through FIG. 3C show a case that an illegal operation is actually performed, and FIG. 4A through FIG. 4C show a case that an illegal operation is not performed.

In FIG. 3A, in a case that an illegal operation is performed on the card reader 1 or the information processing system “X”, the slave device 20 erases the security data 220 and performs a warning through the state notification line “B”. In FIG. 3B, when the master device 10 detects an inversion of the state notification line “B”, the master device 10 transmits a state notification request command through the communication line “C”. In FIG. 3C, when the slave device 20 receives the state communication request command which is transmitted through the communication line “C”, the slave device 20 replies response data indicating the “illegally operated” state. When the response data indicating the “illegally operated” state are returned, the master device 10 recognizes as a security error state and limits the function capable of being executed.

On the other hand, FIG. 4A shows a case that the logic of the state notification line “B” is inverted due to noise or the like. In this case, the security data 220 remain stored in the recording medium of the control part 21. In FIG. 4B, also in this case, the master device 10 has detected the inversion of the state notification line “B” and thus, the master device 10 transmits the state notification request command through the communication line “C”. In FIG. 4C, the slave device 20 receives the state communication request command transmitted through the communication line “C” and replies the notification of a “no illegally operated” state as the response data. When the master device 10 receives the response data indicating the “no illegally operated” state, the master device 10 determines that the logic inversion of the state notification line “B” is malfunction due to noise and does not limit the function or the like and later processing can be performed.

[Principal Effects in this Embodiment]

The embodiment of the present invention is structured as described above and thus, the following effects can be obtained. Conventionally, as described in Patent Literature 1, there is a system in which a state of a slave device is notified between a master device and the slave device. For example, there exists a system in which a state notification request command is transmitted from the master device through a communication line which connects the master device with the slave device, and that the slave device receives it and returns the present state to the master device as a response. However, in such a system, the master device is required to periodically execute communication with the slave device. In other words, the processing of communication for monitoring is always required to perform in the processing of normal operation of the master device and thus a processing load is large. Therefore, the processing of communication for monitoring is conflicted with other processing of the master device and thus, a delay of a processing time of other processing may be occurred.

On the other hand, the card reader 1 in accordance with at least an embodiment of the present invention is an information processing device in which the master device 10 and the slave device 20 are capable of communicating with each other, and the state notification line “B” for notifying a state of the slave device 20 and the communication line “C” for transmitting and receiving an instruction and data are connected between the master device 10 and the slave device 20. The master device 10 includes the state notification detection part 100 which detects a state notification from the slave device 20 through the state notification line “B”, the state request part 110 which transmits a state request command that is an instruction for making transmit data indicating a state through the communication line “C” when the state notification is detected by the state notification detection part 100, and the state processing execution part 120 which performs processing corresponding to the state when the data indicating the state through the state request part 110 are acquired. The slave device 20 includes the state notification part 200 which performs a state notification to the master device 10 through the state notification line “B” corresponding to a change of the state, and the state reply part 210 which replies the data indicating the state when the state request command from the master device 10 is received through the communication line “C” corresponding to the state notification by the state notification part 200. According to this structure, while always monitoring through the state notification line “B” with less influence on other processing, the state of the slave device 20 can be acquired by a command. Therefore, a processing load of state recognition of the slave device 20 can be reduced.

On the other hand, it is conceivable to configure that a state notification line which is a signal line is connected between the master device 10 and the slave device 20 and, when a state to be detected of the slave device 20 is changed, a logic of the state notification line is inverted to notify the change of the state to the master device 10. In this case, the master device 10 periodically monitors the state notification line and, when a change of the state notification line is received, the change of the state is recognized. However, when the signal line is simply monitored, although influence on a processing load is reduced, in a case that the logic of the state notification line is inverted due to noise which is entered into the state notification line or the like, the master device 10 may erroneously recognize the change of the state. In this case, it is conceivable that, even when the logic of the signal line is inverted, it is not immediately determined that the state is changed, and it is confirmed and determined that the state has been changed only when the change is continued over a certain predetermined time period in later monitoring of the signal line. However, this measure is difficult for continuous noise exceeding the certain predetermined time period previously set. On the other hand, the card reader 1 in this embodiment is capable of preventing erroneous recognition of the change of the state caused by an inversion of the state notification line “B” due to noise by confirming the change of the state through communication. Therefore, the change of the state can be recognized surely even if noise is entered.

In the card reader 1 in accordance with at least an embodiment of the present invention, the state notification is a notification of a state corresponding to warning of security, and the state processing execution part 120 executes processing relating to a security error. According to this structure, a case of warning of security is distinguished from malfunction due to noise, and the change of the state can be recognized surely.

In the card reader 1 in accordance with at least an embodiment of the present invention, the master device 10 is a main processing device which performs monitoring of a state of a detection sensor for a card medium 3 and controls various drive mechanisms, and the slave device 20 is a sub-processing device in which encryption of information is executed, encrypted information is processed, and writing and reading of information to and from the card medium 3 are controlled. According to this structure, while the master device 10 monitors a state of the slave device 20 which performs processing regarding encryption with less processing load, malfunction due to noise and the like can be prevented. As a result, security can be improved.

In the card reader 1 in accordance with at least an embodiment of the present invention, the information processing device is a card reader. According to this structure, in the card reader including the master device 10 and the slave device 20, the card reader 1 can be provided in which a processing load in the master device 10 is reduced and a change of the state is recognized surely.

### Other Embodiments

In the embodiment described above, an output of the state notification line “B” is an output from the control part 21. However, an output of the state notification line “B” may be a direct output which is directly outputted from a circuit board of the slave device 20. In addition, an output from the disassembly detection switch 40, a disassembly detection switch, a case intrusion switch of a housing or the like may be used as an output of the state notification line “B”. According to this structure, even when an illegal operation is not temporarily detected by the control part 21, the state can be notified to the master device 10. Also in this case, the slave device 20 may also acquire an output of the state notification line “B” to detect an illegal operation.

In addition, it may be structured that the state notification line “B” in itself does not use a physical conducting wire, and that the state is notified by a pair of a light emitting part and a light receiving part of an optical sensor, an electrostatic capacitance sensor or the like. Further, an arbitrary communication system may be used for the communication line “C”. For example, the UART, I2C or USB may be utilized. According to this structure, it can be adaptable to a flexible configuration.

In the embodiment described above, the security data 220 are erased immediately after an illegal operation is detected by the control part 21. However, it may be configured that the state notification line “B” and a power supply of the slave device 20 are interlocked with each other and the security data 220 stored in a volatile recording medium of the control part 21 are erased according to a change of the state notification line “B”. In addition, it may be configured that the control part 21 erases the security data 220 after receiving a command from the master device 10. This command may be a different command from the state request command. According to this structure, a possibility that the security data 220 are erased due to erroneous detection due to noise or the like can be reduced. In addition, the security level can be set flexibly.

In the embodiment described above, although the state is not changed, in a case that the state notification line “B” remains inverted and is not returned to the original state for some reasons, the master device 10 repeatedly transmits the state notification request command. Therefore, it may be configured that an upper limit of the continuous transmission number of times of the state notification request command from the master device 10 within a particular time period is set and, when the transmission number of times has reached to the upper limit, it is determined that hardware abnormality of the state notification line “B” has occurred. In this case, the hardware abnormality may be notified to the host apparatus 2.

In addition, in the embodiment described above, recognition of the states such as the “illegally operated” state and the “no illegally operated” state is determined on the basis of a content of the response data of the state notification request command. However, the state may be determined by presence and absence of the response. In other words, it may be configured that a case that there is no response means that an illegal operation has been detected. In addition, it may be configured that response data of the state notification command are encrypted. According to this structure, even in a state that the control part 21 is not operated, it can be recognized by the master device 10 that an illegal operation has been performed. In addition, hacking or the like can be coped with. Therefore, the security can be improved.

In the embodiment described above, an illegal operation is detected as a change of the state and a state notification is performed, but at least an embodiment of the present invention is not limited to this example. For example, at least an embodiment of the present invention may be applied to various state notifications such as completion of magnetic reading and completion of encryption processing. According to this structure, a processing load of the master device 10 can be reduced and, while preventing malfunction due to noise and the like, various state notifications can be performed.

In the embodiment described above, as an example, the master device 10 and the slave device 20 are structured as the card reader 1. However, an information processing system “X” (information processing device) in which the host apparatus 2 is the master device 10 and the card reader 1 is the slave device 20 may be configured so as to execute the respective processings in the embodiment described above. In this case, it may be structured that the state notification line is connected with the card reader 1 and the host apparatus 2 and a command is transmitted and received by using the communication line “D”.

In addition, in the embodiment described above, the card reader 1 executes the above-mentioned various processings. However, at least an embodiment of the present invention may be applied to an information processing device which is capable of communicating between the master device 10 and the slave device 20 other than the card reader.

Although the present invention has been shown and described with reference to a specific embodiment, various changes and modifications will be apparent to those skilled in the art from the teachings herein.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An information processing device comprising:
a master device and a slave device structured to communicate with each other;
a state notification line connected between the master device and the slave device structured to perform a state notification of the slave device; and
a communication line connected between the master device and the slave device structured to transmit and receive an instruction and data;
wherein the master device comprises:
a state notification detection part structured to detect the state notification from the slave device through the state notification line;
a state request part structured to transmit a state request command through the communication line, the state request command being the instruction for making transmit data indicating a state in a case that the state notification is detected by the state notification detection part; and
a state processing execution part structured to perform processing corresponding to the state in a case that the data indicating the state are acquired by the state request part; and
wherein the slave device comprises:
a state notification part structured to perform the state notification to the master device through the state notification line corresponding to a change of the state; and
a state reply part structured to reply the data indicating the state in a case that the state reply part receives the state request command from the master device through the communication line corresponding to the state notification of the state notification part.

2. The information processing device according to claim 1, wherein
the state notification is a notification of the state corresponding to warning of security caused by an illegal operation, and
the state processing execution part is structured to execute the processing relating to a security error when the illegal operation has been performed.

3. The information processing device according to claim 1, wherein
the master device is a main processing device structured to monitor a state of a card medium detection sensor and control various drive mechanisms, and
the slave device is a sub-processing device structured to execute encryption of the information, processes the encrypted information, and control writing and reading of information to and from a card medium.

4. The information processing device according to claim 1, wherein the information processing device is a card reader.

5. An information processing method executed by an information processing device comprising a master device and a slave device capable of communicating with each other, a state notification line connected between the master device and the slave device for performing a state notification of the slave device, and a communication line connected between the master device and the slave device for transmitting and receiving an instruction and data, the information processing method comprising:
performing the state notification by the slave device to the master device through the state notification line corresponding to a change of the state;
detecting the state notification by the master device from the slave device through the state notification line;
in a case that the state notification is detected, transmitting by the master device a state request command which is the instruction for making transmit data indicating the state through the communication line;
replying the data indicating the state by the slave device in a case that the state request command is received from the master device through the communication line corresponding to the state notification; and
performing processing corresponding to the state by the master device in a case that the data indicating the state are acquired.

6. The information processing device according to claim 2, wherein
the master device is a main processing device which monitors a state of a card medium detection sensor and controls various drive mechanisms, and
the slave device is a sub-processing device which executes encryption of the information, processes the encrypted information, and controls writing and reading of information to and from a card medium.

7. The information processing device according to claim 2, wherein the information processing device is a card reader.

8. The information processing device according to claim 3, wherein the information processing device is a card reader.

9. The information processing device according to claim 6, wherein the information processing device is a card reader.
